(19) United States
(12) Patent Application Publication
(10) Pub. No.: US 2020/0238979 A1
(43) Pub. Date: Jul. 30, 2020

(54) AUTOMATIC PARKING CONTROL APPARATUS AND METHOD

(71) Applicant: Mando Corporation, Pyeongtaek-si (KR)

(72) Inventors: Hyeong Min Woo, Seongnam-si (KR); Jae Suk Kim, Yongin-si (KR)

(21) Appl. No.: 16/743,897

(22) Filed: Jan. 15, 2020

(30) Foreign Application Priority Data
Jan. 29, 2019 (KR) 10-2019-0010956

(51) Int. Cl. B60W 30/06; G06K 9/00; B60R 11/04

(52) U.S. Cl. CPC B60W 30/06; G06K 9/00812; G06K 9/00805; B60W 2554/402; B60R 2300/806; B60W 2420/54; B60W 2554/20; B60R 11/04

(57) ABSTRACT

The present disclosure relates to an automatic parking control apparatus and method. The automatic parking control apparatus for automatically parking a vehicle includes a plurality of sensors and a plurality of cameras provided outside the vehicle and a control device provided inside the vehicle to automatically park the vehicle by selectively using data of the sensors and cameras.

### CROSS-REFERENCE TO RELATED APPLICATION

This application claims priority to and the benefit of Korean Patent Application No. 2019-0010956, filed on Jan. 29, 2019, the disclosure of which is incorporated herein by reference in its entirety.

### BACKGROUND

### 1. Field of the Invention

The present disclosure relates to an automatic parking control apparatus and method, and more particularly, to an automatic parking control apparatus and method that allows a user to park a vehicle stably and automatically at a desired location.

### 2. Discussion of Related Art

An automatic parking system of an automobile identifies a parking space using a plurality of sensors mounted outside the automobile and allows the automobile to travel automatically to the parking space and to then park stably.

The plurality of sensors can include one or more among a camera, an ultrasonic sensor, and a radar. Furthermore, use of an internal sensor of the automobile allows a steering angle, a speed, a transmission-gear-select-position, etc. to be detected during parking.

An automatic parking control apparatus and method as described above can be confirmed in U.S. Pat. No. 10,025,997B2 or the like.

### SUMMARY OF THE INVENTION

The present disclosure is directed to providing an automatic parking control apparatus and method that is capable of searching for parking spaces using an external sensor and enables a driver to easily select one of the searched parking spaces and automatically park.

In particular, the present disclosure is directed to providing an automatic parking control apparatus and method that appropriately selects and uses an external sensor according to purposes thereof and automatically parks a vehicle using the minimum information.

The present disclosure is directed to providing an automatic parking control apparatus and method in which the external sensor uses only a camera and an ultrasonic sensor and which calculates a distance to a parking location, determines a parking space, determines a parking scenario, and detects a parking line by selectively using detection data of the camera and the ultrasonic sensor.

Furthermore, the present disclosure is directed to providing an automatic parking control apparatus and method that is capable of detecting a surrounding obstacle while automatically parking a vehicle and changing the parking control according to the obstacle.

The present disclosure is directed to providing an automatic parking control apparatus and method that is capable of changing parking control according to a scenario preset on the basis of whether an obstacle moves and a moving speed thereof.

According to an aspect of the present disclosure, there is provided an automatic parking control apparatus for automatically parking a vehicle, including a plurality of sensors and a plurality of cameras provided outside the vehicle and a control device provided inside the vehicle to control automatic parking of the vehicle by selectively using data of the plurality of sensors and the plurality of cameras.

The plurality of sensors may include ultrasonic sensors, and the control device may calculate parking spaces and distances using data of the ultrasonic sensors.

The plurality of sensors may include temperature sensors, and the control device may compensate for the calculated parking spaces and distances according to temperatures measured by the temperature sensors.

The control device may determine parking spaces using detection data of ultrasonic sensors included in the plurality of sensors.

The control device may calculate distances to parking spaces using detection data of ultrasonic sensors included in the plurality of sensors.

The control device may determine a parking scenario according to the forms of parking spaces captured by the plurality of cameras.

The control device may detect parking lines from images captured by the plurality of cameras.

The control device may include a control unit and a display unit and may display, on the display unit, a top view image that includes parking spaces and is obtained by processing images captured by the plurality of cameras.

The automatic parking control apparatus may be configured to automatically park the vehicle in one of the parking spaces that is selected from the top view image displayed on the display unit.

The control device may detect, during parking control, an obstacle through detection data of the plurality of sensors and image data of the plurality of cameras and compensate for the parking control.

The control device may classify the obstacle as a person, another vehicle, a pillar, a wall, or other unclassified obstacles and compensate for the parking control according to a scenario based on a classification result.

According to another aspect of the present disclosure, there is provided an automatic parking control method for controlling automatic parking to one of parking spaces, which are displayed on a display unit, selected by a driver in a top view image including the parking spaces.

The parking space may be determined through a plurality of ultrasonic sensors provided outside a vehicle.

The top view image may be generated by processing, in a control unit, images captured by a plurality of cameras provided outside the vehicle.

The automatic parking may be controlled according to a scenario that matches the form of the selected parking space captured by a camera.

The control of the automatic parking may be compensated for when an obstacle is detected using the camera and an ultrasonic sensor.

The obstacle may be classified as a person, another vehicle, a pillar, a wall, or other unclassified obstacles, and the control of the automatic parking may be compensated for according to a scenario based on a classification result.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram of an automatic parking control apparatus according to an exemplary embodiment of the present disclosure;

FIG. 2 is a block diagram of the automatic parking control apparatus according to the exemplary embodiment of the present disclosure;

FIG. 3 is a table showing whether a control device uses data of an ultrasonic sensor or a camera according to objects;

FIG. 4 is an example of an image displayed on a display unit; and

FIG. 5 is a flowchart of an automatic parking control method according to the present disclosure.

### DETAILED DESCRIPTION OF EXEMPLARY EMBODIMENTS

Hereinafter, an automatic parking control apparatus and method according to the present disclosure will be described in detail with reference to the accompanying drawings.

Embodiments of the present disclosure are provided to more fully describe the present disclosure to those skilled in the art. The embodiments described below can be modified in various other forms, and the scope of the present disclosure is not limited to the following embodiments. Rather, these embodiments are provided so that this disclosure will be more thorough and complete and will fully convey the scope of the invention to those skilled in the art.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof but do not preclude the presence or addition of one or more other features, integers, steps, operations, elements, components, and/or groups thereof. As used herein, the term “and/or” includes any and all combinations of one or more of the associated listed items.

It should be obvious that although the terms “first”, “second”, etc. may be used herein to describe various elements, areas, and/or portions, these elements, components, areas, layers, and/or portions should not be limited by these terms. The terms do not mean a particular order, top and bottom, or merits and demerits but are only used to distinguish one element, area, or portion from another. Accordingly, a first element, area, or portion which will be described below may indicate a second element, area, or portion without deviating from teachings of the present disclosure.

Hereinafter, embodiments of the present disclosure will be described with reference to schematic views illustrating the embodiments of the present disclosure. In the drawings, modifications of the shape shown may be estimated according to, for example, manufacturing techniques and/or tolerances. Thus, embodiments of the present disclosure should not be construed as limited to any particular shape of the regions illustrated herein, including, for example, variations in shape resulting from manufacturing.

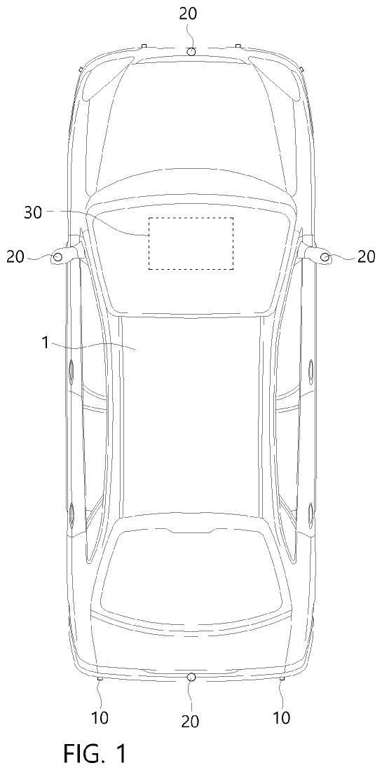

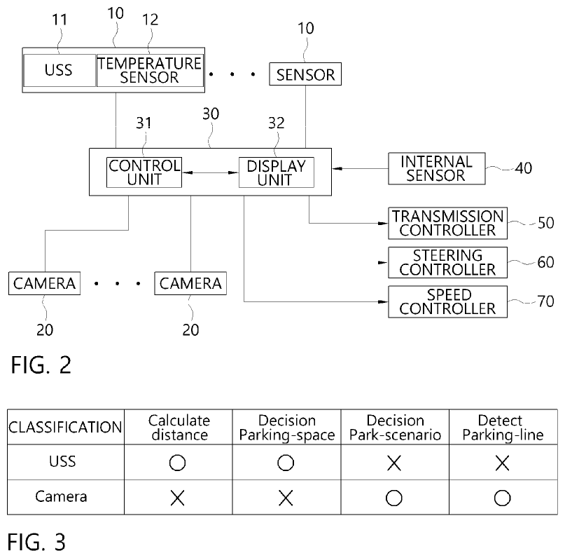

FIG. 1 is a conceptual diagram of an automatic parking control apparatus according to an exemplary embodiment of the present disclosure, and FIG. 2 is a block diagram of the automatic parking control apparatus according to the exemplary embodiment of the present disclosure.

Referring to FIGS. 1 and 2, the automatic parking control apparatus, according to the present disclosure, includes a plurality of sensors 10 provided outside a vehicle 1, a plurality of cameras 20 installed outside the vehicle to capture a surroundings thereof, and a control device 30 that controls automatic parking of the vehicle 1 by selectively using data or image signals detected by the sensors 10 and the cameras 20.

The control device 30 includes a control unit 31 and a display unit 32.

The control device 30 may control automatic parking by controlling a transmission controller 50 and a steering controller 60 while identifying a detection result of an internal sensor 40.

As configured above, the configuration and operation of the automatic parking control apparatus according to an exemplary embodiment of the present disclosure will hereinafter be described in detail.

The sensors 10 may include ultrasonic sensors 11.

Further, at least one of the sensors 10 may include a temperature sensor 12.

The sensors 10 are installed outside the vehicle 1. The ultrasonic sensors 11 may measure distances using the reflected waves of ultrasonic waves. At this time, since the speed of sound waves changes depending on temperatures, an accurate temperature is measured using the temperature sensor 12.

The temperature measured by the temperature sensor 12 is transmitted to the control device 30, and thus the distances detected by the ultrasonic sensors 11 may be compensated for on the basis of the speed of sound waves depending on the current temperature.

The cameras 20 are installed outside or inside the vehicle 1. Front, rear, left, and right surfaces of the vehicle 1 may be captured using, preferably, four cameras 20.

Images captured by the cameras 20 are displayed on the display unit 32 of the control device 30. In this case the displayed images will be described in more detail later.

The control device 30 uses data detected by the ultrasonic sensors 11 of the sensors 10 or the images captured by the cameras 20 according to objects to be calculated, detected, or determined.

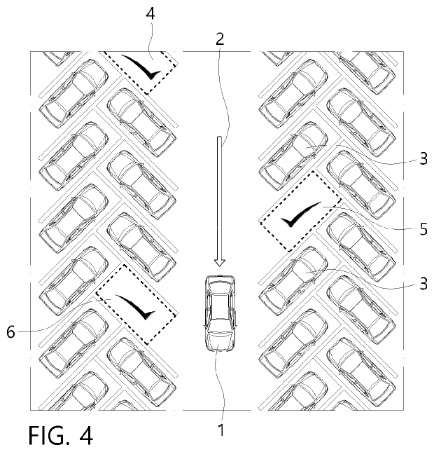

FIG. 3 is a table showing whether the control device 30 uses data of the ultrasonic sensors 11 or the cameras 20 according to objects.

Referring to FIG. 3, the control device 30 uses data of the ultrasonic sensors 11 and does not use image data of the cameras 20 in order to calculate a distance.

The control device 30 uses data of the ultrasonic sensors 11 and does not use image data of the cameras 20 to determine a parking space.

The control device 30 does not use data of the ultrasonic sensors 11 and uses image data of the cameras 20 in order to determine a parking scenario.

The control device 30 does not use data of the ultrasonic sensors 11 and uses image data of the cameras 20 in order to detect a parking line.

In this manner, the control device 30 may reduce the amount of computation by selectively using different data according to the objects to be calculated, detected, or determined. Further, by using the ultrasonic sensors 11 and the cameras 20, which are relatively inexpensive, data required for automatic parking control may be secured.

FIG. 4 is an example of an image displayed on the display unit 32.

It is assumed that the vehicle 1 moves along a moving path 2 of a parking lot in order to identify a parking space.

When the vehicle 1 moves along the moving path 2, the cameras 20 may capture surrounding images and measure a distance between parked vehicles 3 and the parking space through the ultrasonic sensors 11 of the sensors 10.

A first parking space 4, a second parking space 5, and a third parking space 6 are detected, and the control unit 31 of the control device 30 generates a top view image using data on surrounding images of, and distances for, the moving path 2 along which the vehicle 1 has moved and displays the generated top view image on the display unit 32.

The display unit 32 is a touchscreen, and a driver selects, on the display unit 32, a desired one of the detected first parking space 4, second parking space 5, and third parking space 6 in which the driver desires to park.

When the driver selects the desired parking space, the selection information is provided to the control unit 31, and the control unit 31 allows the vehicle 1 to move to the selected parking space.

The vehicle 1 is moved according to distance information produced using data of the ultrasonic sensors 11.

When the driver selects the first parking space 4, the control unit 31 obtains required information from the internal sensor 40 and controls the transmission controller 50 and the steering controller 60 to allow the vehicle 1 to move to the first parking space 4.

Various techniques capable of automatically moving the vehicle 1 to a desired location are known, and one of the known techniques is selectively used in the present disclosure.

The technique selectively used in the present disclosure simply differs from the known techniques in that a moving distance is calculated on the basis of data of the ultrasonic sensors 11.

The internal sensor 40 may include a transmission selection position sensor, a steering angle sensor, and an acceleration sensor.

Based on the image displayed on the display unit 32, the current transmission position may be “drive,” and the internal sensor 40 is checked.

An optimal scenario for moving to the first parking space 4 selected by the driver is determined by the control unit 31 on the basis of images captured by the cameras 20.

By default, a scenario is determined such that the vehicle 1 may move from the current location to the first parking space 4 by the shortest distance. When there is another vehicle or an obstacle on the shortest path, a scenario for reaching the first parking space 4 by bypassing the other vehicle or the obstacle is determined.

Based on the image displayed on the display unit 32, the shortest distance is in a direction reverse to the moving path 2. The current transmission selection is identified through the internal sensor 40, and when the current transmission selection is not “reverse,” the transmission controller 50 is controlled such that a gearshift lever is shifted to “reverse.”

The control unit 31 identifies the current steering angle through the internal sensor 40 and controls the steering controller 60 such that the current steering angle is adjusted to a steering angle at which the vehicle 1 may move to the first parking space 4.

Then, the control unit 31 controls a speed controller 70 to allow the vehicle 1 to move.

At this time, the control unit 31 of the control device 30 checks image data captured by the cameras 20 to identify whether there is a new obstacle while the vehicle 1 moves according to a selected scenario.

Further, the control unit 31 checks data of the ultrasonic sensors 11 in order to reduce the number of errors in the measured distances and modifies the scenario while identifying distances to obstacles, including the parked vehicles 3. That is, the control unit 31 compensates for control.

The control unit 31 controls automatic parking by controlling the transmission controller 50, the steering controller 60, and the speed controller 70 according to a parking scenario determined in a state in which the vehicle 1 approaches the first parking space 4.

The parking scenario may be classified into a parallel parking scenario, a right-angle parking scenario, and an inclined parking scenario according to the types of the first parking space 4.

Further, the control unit 31 may identify whether a bottom surface of the first parking space 4 is flat or inclined and include additional acceleration and deceleration scenarios according to the gradients.

The control unit 31 compensates for control such that the parking line may be detected using the cameras 20 and the vehicle 1 may be safely parked within the parking line, while controlling automatic parking of the vehicle 1 according to the parking scenario determined in such a manner.

While controlling parking, the control unit 31 identifies data detected by the ultrasonic sensors 11 to check distances to the surrounding parked vehicles 3, thereby compensating for paths and control on a real time basis.

While controlling parking, the control unit 31 identifies whether there is a new obstacle through the cameras 20. When there is an obstacle, the control unit 31 determines the type of the obstacle.

The control unit 31 may determine the type of the obstacle by identifying the shape of the obstacle and whether the obstacle moves.

By using the shape of the obstacle, the control unit 31 may classify the obstacle as a person, another vehicle, a pillar, a wall, and others.

Even when the obstacle is determined as a person or another vehicle using the shape, if there is no movement thereof, the control unit 31 may classify the obstacle as others.

The control unit 31 compensates for control according to a scenario predetermined on the basis of this classification.

For example, when a person is detected during parking control and the person moves, the control unit 31 stops the parking control until the person completely leaves a parking space and controls the vehicle 1 such that the vehicle 1 stops.

At this time, for safety, the control unit 31 controls the transmission controller 50 such that the gearshift lever is positioned in a parking position P, and controls the speed controller 70 such that the speed becomes zero.

When the obstacle identified during parking control is another vehicle, the control unit 31 identifies whether the other vehicle approaches or recedes using detection data of the ultrasonic sensors 11.

When the other vehicle approaches, the control unit 31 controls the vehicle 1 such that the vehicle 1 stops or sounds the horn to enable the other vehicle's driver to recognize the location of the vehicle 1.

When the identified obstacle is a pillar, a wall, or other obstacles, the control unit 31 controls parking such that the vehicle 1 avoids the obstacle.

As described above, the present disclosure may selectively control automatic parking using only the detection data of the ultrasonic sensors 11 and the image data of the cameras 20.

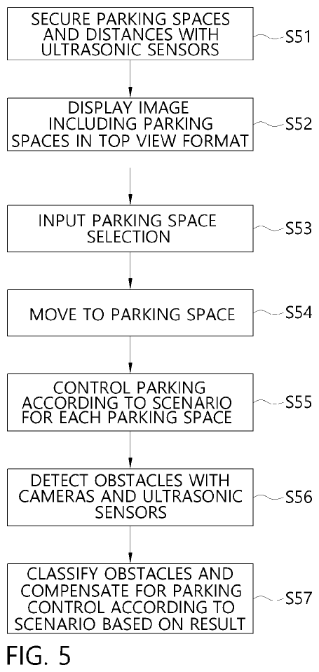

FIG. 5 is a flowchart of an automatic parking control method according to the present disclosure.

The automatic parking control method, according to the present disclosure, includes: identifying parking spaces using the ultrasonic sensors 11 and checking distances to the parking spaces (S51); displaying, on the display unit 32, surrounding images of the vehicle 1 in top view format using image data captured by the cameras 20 (S52); receiving a selection of the parking spaces from a user (S53); moving to the selected parking space (S54); controlling automatic parking to the selected parking space, determining a parking scenario according to parking space types of the images captured by the cameras 20, and controlling parking according to the determined parking scenario (S55); detecting an obstacle through the cameras 20 and the ultrasonic sensors 11 during the parking control (S56); and determining the type of the obstacle when the obstacle exists and compensating for control according to the type of the obstacle (S57).

As configured above, the automatic parking control method will be described in more detail as follows. The automatic parking control method, according to the present disclosure, is carried out by the control unit 31 of the control device 30.

First, as in S51, the vehicle 1 determines parking spaces using distance information obtained through the ultrasonic sensors 11 while travelling within a parking lot and calculates distances to the determined parking spaces.

At this time, the distance information may be compensated for according to temperature information detected by the temperature sensor 12.

Further, as in S52, image data captured by the cameras 20 is processed to be converted into a top view format such that spatial information including the parking spaces may be identified easily, and the converted top view image is displayed on the display unit 32.

At this time, available parking spaces are displayed in the displayed top view image.

Next, as in S53, when a driver selects a specific parking space in a display state of the display unit 32, the control unit 31 determines a scenario for moving to the selected parking space.

The scenario, for example, a moving scenario, is for the purpose of selecting the shortest distance to the selected parking space, and when there is an obstacle, the control unit 31 determines a scenario for bypassing the obstacle.

Then, as in S54, the control unit 31 allows the vehicle 1 to move to the selected parking space according to the determined scenario.

At this time, the control unit 31 monitors the appearance of an obstacle using the cameras 20 and the ultrasonic sensors 11 and compensates for control for modifying the moving scenario when the obstacle appears.

Thereafter, as in S55, the control unit 31 performs automatic parking to the selected parking space in a state in which the vehicle 1 has moved to a location adjacent to the selected parking space.

At this time, the control unit 31 identifies the image data obtained through the cameras 20, determines a parking scenario that matches the shape of the parking space, and performs parking according to the determined parking scenario.

In sequence, as in S57, the control unit 31 identifies the data of the cameras 20 and the ultrasonic sensors 11 during the parking control to check whether there is an obstacle.

The obstacle may be classified as a person, another vehicle, a pillar, a wall, or other obstacles, and the classification may be made on the basis of the image data of the cameras 20.

Parking control may be compensated for according to types of the classified obstacle.

When the obstacle is a person, the control unit 31 may perform control compensation for stopping the vehicle 1 until the person completely leaves the parking space.

When the obstacle is another vehicle and is approaching the vehicle 1, the control unit 31 may perform control compensation for stopping the vehicle 1 and sounding the horn thereof.

When the obstacle is a pillar or wall, the control unit 31 performs control compensation such that the vehicle 1 may avoid the pillar or wall and park.

As described above, the present disclosure enables the driver to safely park in a desired parking space.

Further, pieces of data required for parking control may be obtained using the ultrasonic sensors and the cameras.

According to the abovementioned embodiments, the automatic parking control apparatus and method, according to the present disclosure, can improve user convenience by enabling the driver to select, from among searched parking spaces, a location at which the driver desires to park.

External sensors are limited for automatic parking control, some of the external sensors are appropriately selected according to an object to be detected, and automatic parking can be controlled using a minimum of sensor data.

The present disclosure can automatically park the vehicle using only the ultrasonic sensors and the cameras, which are relatively inexpensive.

The present disclosure can detect obstacles while automatically parking the vehicle, and automatically park the vehicle avoiding the obstacles, thereby preventing a collision with the obstacles during the parking.

The present disclosure can control automatic parking in consideration of whether the detected obstacles have moved and moving speeds thereof, thereby preventing a collision with another vehicle or a person.

It would be obvious to those skilled in the art that the prevent invention is not limited to the aforementioned embodiments and may be modified and varied without departing from a technical subject matter of the present disclosure.

What is claimed is:

1. An automatic parking control apparatus for automatically parking a vehicle, the automatic parking control apparatus comprising:
a plurality of sensors and a plurality of cameras provided outside or inside the vehicle; and
a control device provided inside the vehicle to control automatic parking,
wherein the control device controls automatic parking of the vehicle by selectively using data of the plurality of sensors and the plurality of cameras.

2. The automatic parking control apparatus of claim 1, wherein the plurality of sensors include ultrasonic sensors, and the control device calculates parking spaces and distances using data of the ultrasonic sensors.

3. The automatic parking control apparatus of claim 2, wherein the plurality of sensors include temperature sensors, and the control device compensates for the calculated parking spaces and distances according to temperatures measured by the temperature sensors.

4. The automatic parking control apparatus of claim 1, wherein the control device determines parking spaces using detection data of ultrasonic sensors included in the plurality of sensors.

5. The automatic parking control apparatus of claim 1, wherein the control device calculates distances to parking spaces using detection data of ultrasonic sensors included in the plurality of sensors.

6. The automatic parking control apparatus of claim 1, wherein the control device determines a parking scenario according to the forms of parking spaces captured by the plurality of cameras.

7. The automatic parking control apparatus of claim 1, wherein the control device detects parking lines from images captured by the plurality of cameras.

8. The automatic parking control apparatus of claim 1, wherein the control device includes a control unit and a display unit, and displays, on the display unit, a top view image that includes parking spaces and is obtained by processing images captured by the plurality of cameras.

9. The automatic parking control apparatus of claim 8, configured to automatically park the vehicle in one of the parking spaces that is selected from the top view image displayed on the display unit.

10. The automatic parking control apparatus of claim 1, wherein the control device detects, during parking control, an obstacle through detection data of the plurality of sensors and image data of the plurality of cameras and compensates for the parking control.

11. The automatic parking control apparatus of claim 10, wherein the control device classifies the obstacle as a person, another vehicle, a pillar, a wall, or other unclassified obstacles and compensates for the parking control according to a scenario based on a classification result.

12. An automatic parking control method for controlling automatic parking to one of parking spaces, which are displayed on a display unit, selected by a driver in a top view image including the parking spaces.

13. The automatic parking control method of claim 12, wherein the parking space is determined through a plurality of ultrasonic sensors provided outside a vehicle.

14. The automatic parking control method of claim 12, wherein the top view image is generated by processing, in a control unit, images captured by a plurality of cameras provided outside a vehicle.

15. The automatic parking control method of claim 12, wherein the automatic parking is controlled according to a scenario that matches the form of the selected parking space captured by a camera.

16. The automatic parking control method of claim 15, wherein the control of the automatic parking is compensated for when an obstacle is detected using the camera and an ultrasonic sensor.

17. The automatic parking control method of claim 16, wherein the obstacle is classified as a person, another vehicle, a pillar, a wall, or other unclassified obstacles and the control of the automatic parking is compensated for according to a scenario based on a classification result.
